(19) United States
(12) Patent Application Publication
(10) Pub. No.: US 2008/0065330 A1
(43) Pub. Date: Mar. 13, 2008

(54) Electromagnetic Data Processing

(76) Inventors: Tage Rosten, Trondheim (NO); Lasse Amundsen, Trondheim (NO)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/547,318

(22) PCT Filed: Apr. 1, 2005
(86) PCT No.: PCT/EP05/51480

§ 371 Date: Nov. 16, 2006

(30) Foreign Application Priority Data
Apr. 3, 2004 (GB) 0407699.8

(51) Int. Cl. G01V 3/12

(52) U.S. Cl. 702/8; 702/57

(57) ABSTRACT

A method of determining the source radiation pattern of at least one source (2) of electromagnetic radiation is provided. The method comprises the steps of at at least one sensor (3), measuring the electric and magnetic fields due to the at least one source; formulating a surface integral over the measured data, the measured data weighted by a Green's function and its spatial derivatives; and evaluating the surface integral at at least one location to determine the source radiation pattern at that location due to the at least one source.

The present invention relates to a method of determining the radiation pattern of an electromagnetic source and use of knowledge of this data. The present invention may be used, for example, in identifying the source radiation pattern due to known or unknown sources in the field of electromagnetic seabed logging.

The electromagnetic seabed logging (EM-SBL) technique is a new hydrocarbon exploration tool based on electromagnetic data, and is disclosed in Eidesmo et al., (2002) “Sea Bed Logging, a new method for remote and direct identification of hydrocarbon filled layers in deepwater areas”, The Leading Edge, 20, No. 3, 144-152 and in Ellingsrud et al., (2002) ‘Remote sensing of hydrocarbon layers by seabed logging SBL: Results from a cruise offshore Angola”, First Break, 21, No. 10, 972-982. EM-SBL is a special application of controlled-source electromagnetic (CSEM) sounding. CSEM sounding has been used successfully for a number of years to study ocean basins and active spreading centres. SBL is the first application of CSEM for remote and direct detection of hydrocarbons in marine environments. The two first successful SBL surveys published were offshore West Africa (Eidesmo et al and Ellingsrud et al above) and offshore mid-Norway, Røsten et al., (2003) “A Seabed Logging Calibration Survey over the Ormen Lange gas field”, EAGE, 65^{th} An. Internat. Mtg., Eur. Assoc. Geosc. Eng., Extended Abstracts, P058. Both studies were carried out in deep water environments (greater than 1,000 metre water depth).

The method uses a horizontal electrical dipole (HED) source that emits a low frequency electromagnetic signal into the underlying seabed and downwards into the underlying sediments. Electromagnetic energy is rapidly attenuated in the conductive subsurface sediments due to water-filled pores. In high-resistance layers such as hydrocarbon-filled sandstones and at a critical angle of incidence, the energy is guided along the layers and attenuated to a lesser extent. Energy refracts back to the seabed and is detected by electromagnetic receivers positioned thereupon. When the source-receiver distance (i.e. the offset) is of the order of 2 to 5 times the depth of the reservoir, the refracted energy from the resistive layer will dominate over directly transmitted energy. The detection of this guided and refracted energy is the basis of EM-SBL.

The thickness of the hydrocarbon-filled reservoir should be at least 50 m to ensure efficient guiding along the high-resistance layer and the water depth should ideally be greater than 500 m to prevent contributions from air waves known as ghosts.

The electromagnetic energy that is generated by the source is spread in all directions and the electromagnetic energy is rapidly attenuated in conductive subsea sediments. The distance to which the energy can penetrate into the subsurface is mainly determined by the strength and frequency of the initial signal, and by the conductivity of the underlying formation. Higher frequencies result in greater attenuation of the energy and hence a lower penetration depth. The frequencies adopted in EM-SBL are therefore very low, typically 0.25 Hz. The electric permittivity can be neglected due to the very low frequencies, and the magnetic permeability is assumed to be that of a vacuum, i.e. a non-magnetic subsurface.

In terms of numbers, a hydrocarbon-filled reservoir typically has a resistivity of a few tens of ohm-metres or more, whereas the resistivity of the over- and under-lying sediments is typically less than a few ohm-metres. The propagation speed is medium-dependent. In seawater, the speed is approximately 1,700 m/s (assuming a frequency of 1 Hz and a resistivity of 0.3 ohm-m), whereas a typical propagation speed of the electromagnetic field in water-filled subsea sediments is about 3,200 m/s, assuming a frequency of 1 Hz and a resistivity of 1.0 ohm-m. The electromagnetic field in a high-resistance hydrocarbon-filled layer propagates at a speed of around 22,000 m/s (50 ohm-m resistivity and 1 Hz frequency). The electromagnetic skin depths for these three cases are approximately 275 m, 500 m and 3,600 m, respectively.

The electromagnetic receivers may be placed individually on the seabed, each receiver measuring two orthogonal horizontal and one vertical component of each of the electric and magnetic fields. The HED source consists of two electrodes approximately 200 m apart, in electrical contact with the seawater. The source transmits a continuous and periodic alternating current signal, with a fundamental frequency in the range of 0.05-10 Hz. The peak-to-peak AC ranges from zero to several hundred amps. The height of the source relative to the seabed should be much less than the electromagnetic skin depth in seawater to ensure good coupling of the transmitted signal into the subsurface, e.g. around 50-100 m. There are several ways of positioning the receivers on the seabed. Usually, the receivers are placed in a straight line. Several such lines can be used in a survey and the lines can have any orientation with respect to each other.

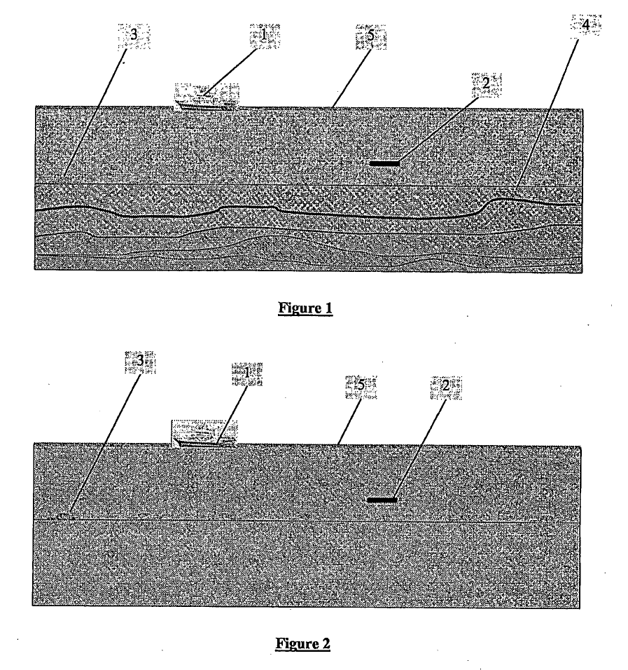

The environment and apparatus for acquiring EM-SBL data are illustrated in FIG. 1. A survey vessel 1 tows the electromagnetic source 2 along and perpendicular to the lines of receivers 3, and both in-line (transverse magnetic) and broad-line (transverse electric) energy can be recorded by the receivers. The receivers on the seabed 4 record data continuously while the vessel tows the source at a speed of 1-2 knots. The EM-SBL data are densely sampled at the source side, typically sampled at 0.04 s intervals. On the receiver side, the data must be sampled according to sampling theorem; see, for example, Antia (1991), “Numerical methods for scientists and engineers”, Tata McGraw-Hill Publ. Co. Limited, New Dehli.

The EM-SBL data are acquired as a time series and then processed using a windowed discrete Fourier series analysis (see, for example, Jacobsen and Lyons (2003) “The Sliding DFT”, IEEE Signal Proc. Mag., 20, No. 2, 74-80) at the transmitted frequency, i.e. the fundamental frequency or a harmonic thereof. After processing, the data can be displayed as magnitude versus offset (MVO) or phase versus offset (PVO) responses.

The electromagnetic source used in EM-SBL surveys may be considered an active source. Other, passive, sources may also be detectable, for example magnetotelluric sources due to sun-spot activity. The total incident electromagnetic field due to all sources, active and passive, including the effect of the sea surface is known as the source radiation pattern. It is a known problem to identify the source electromagnetic radiation pattern due to known or unknown sources disposed above the sensors. Although similar techniques are known for acoustic and seismic surveys, they are not applicable to the electromagnetic case because electromagnetic fields are different in nature to acoustic and seismic fields.

According to a first aspect of the invention, there is provided a method as defined in the appended claim 1.

Further aspects and embodiments of the invention are defined in the other appended claims.

It is thus possible to provide a technique which permits improved determination of the electromagnetic source radiation pattern for an arbitrary Earth. The technique does not require any knowledge of the Earth's internal structure for the region under study nor any information about the nature of the sources, only measurements of the electric and magnetic fields.

For a better understanding of the present invention and in order to show how the same may be carried into effect, preferred embodiments of the invention will now be described, by way of example, with reference to the accompanying drawings in which:

FIG. 1 illustrates the environment and apparatus for the acquisition of EM-SBL data;

FIG. 2 illustrates an idealised water half-space layer in accordance with the method of an embodiment of the present invention;

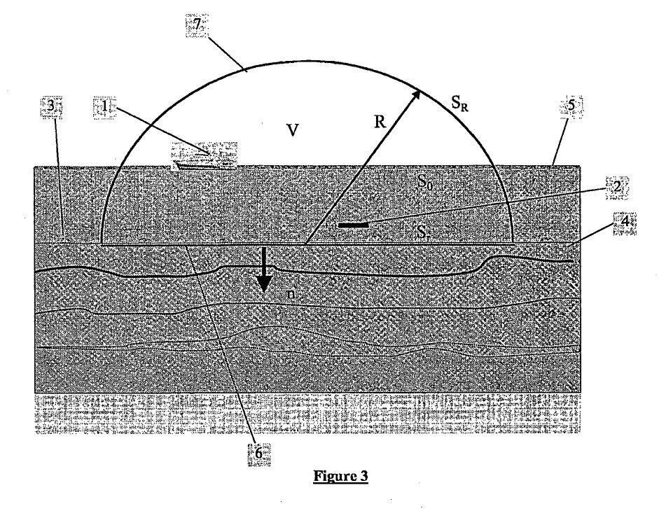

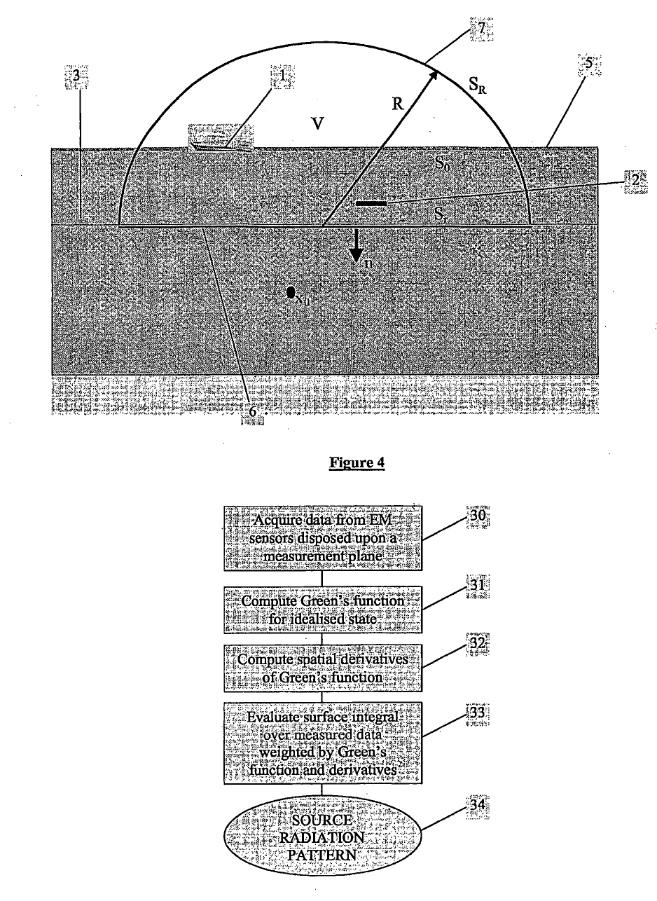

FIGS. 3 and 4 are copies of FIGS. 1 and 2 overlaid with the geometry of the method of an embodiment of the present invention;

FIG. 5 is a flow diagram illustrating a method in accordance with an embodiment of the present invention; and

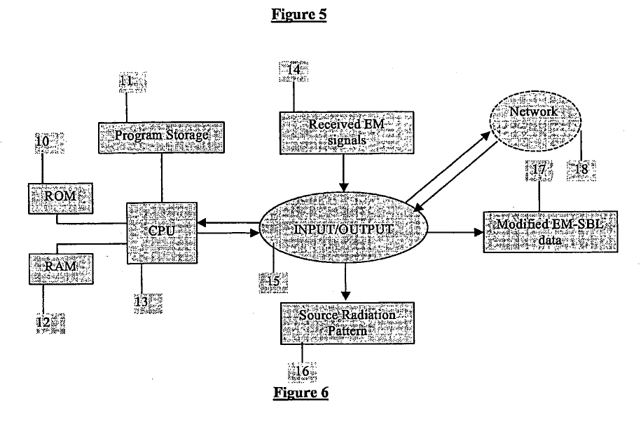

FIG. 6 is a block schematic diagram of an apparatus for performing the method of an embodiment of the present invention.

The technique described herein adopts an electromagnetic integral representation to determine the source radiation pattern. Other techniques may be applied, for example the electromagnetic principle of reciprocity (A. T. deHoop, Handbook of radiation and scattering of waves, Academic Press, 1995), or by frequency-wavenumber domain analysis of Maxwell's equations. Irrespective of the technique used, the general method involves forming a surface integral over the measured electromagnetic data, weighted by a Green's function and its spatial derivatives for an idealised state. The surface integral may be evaluated at any location on or below the plane or line of measurement to directly output the source wavefield at that location.

The integral representation correlates the electromagnetic wave properties that characterise two admissible “states” that might occur in a given spatial volume. The method by which the integral representation is obtained is described below. According to the integral representation, one of the two admissible states can be the actual physical electromagnetic environment. The other state is typically set as a different physical state or an idealised state, but over the same volume. The general form of the integral representation gives the relationship between these two independent states.

According to an embodiment of the present technique, the first state of the integral representation is set to be the physical situation, which shall be described herein as a physical marine electromagnetic survey, e.g. an EM-SBL survey as illustrated in FIG. 1, occurring over an unknown medium bounded above by a water layer. The sources are located at some position above the sensors. The sensors are disposed at some position within the water layer and may be, for example, within the water column or directly in contact with the seabed. The sensors record both the radiation pattern due to the source(s) and the field due to the subsurface. The incident wavefield includes, by definition, the waves reflected and refracted from the surface of the water layer.

The properties of the wavefield due to sources above the sensors are related only to the properties of the water layer and the air-water interface. This is the desired wavefield for extraction from the acquired data.

The second state of the integral representation is chosen to be an idealised electromagnetic survey that occurs in a water half-space bounded above by an air-water interface, as illustrated in FIG. 2. Like numerals represent like features throughout the drawings. FIG. 2 is the same as FIG. 1 in all respects except that there is no seabed; the receivers 3 are not positioned upon a physical surface. In the idealised survey, the data recorded at the receivers will be the incident wavefield due to the source only. For this to hold, the water half-space of the second state must have the same physical properties as the water layer of the first state.

The integral representation gives the relationship between the two described states, allowing the determination of the source radiation pattern from the measured real-world data.

The following notation shall be adopted throughout the remainder of this specification:

| | |
|---|---|
| E = E(x, ω) | Electric field strength |
| H = H(x, ω) | Magnetic field strength |
| J = J(x, ω) | Volume density of eleciric current |
| K = K(x, ω) | Volume density of magnetic current |
| F = F(x, ω) | Volume density of force, F = ζJ − ∇ × K |
| σ = σ(x) | Electric conductivity |
| ε = ε(x) | Electric permittivity |
| \tilde{ε} = \tilde{ε}(x, ω) | $Complex electric permittivity \tilde{ɛ} = ɛ ( 1 + \frac{i σ}{ω ɛ} )$ |
| μ = μ(x) | Magnetic permeability |
| η = η(x, ω) | Transverse admittance per length of the medium, |
| | η = σ − iωε = −iω\tilde{ε} |
| ζ = ζ(x, ω) | Longitudinal impedance per length of the medium, |
| | ζ = −iωμ |
| c = c(x, ω) | Complex velocity, c⁻² = μ\tilde{ε} = −ω⁻² μζ |

where ω is the angular frequency. The wavenumber k is defined by

$$K = \frac{ω}{c} = - {( η ζ )}^{1 / 2} = {ω ( μ \tilde{ɛ} )}^{1 / 2} .$$

The conduction currents and displacement currents have been combined when expressing the complex permittivity \tilde{ε}. For EM-SBL recordings, displacement currents are much smaller than conduction currents. For EM-SBL radiation pattern identification, \tilde{ε} can therefore be approximated to \tilde{ε}=iσ/ω, which is independent of the electric permittivity. Furthermore, the magnetic permeability is set to be μ=μ₀=4π·10⁻⁷ H/m, representative of the non-magnetic water layer. The complex velocity can then be written as c=(ω/(μ₀σ))^{1/2}e^{-iπ/4}. During EM-SBL radiation pattern analysis, the wavenumber k can then be written as k=(iωμ₀σ)^{1/2}. The longitudinal impedance per length is ζ=−iωμ₀.

Green's Vector Theorem

The integral relationship between two vector fields characterising two different states within a volume V shall now be derived. This relationship is also known as the reciprocity theorem or Green's vector theorem.

A volume V is enclosed by a surface S with outward-pointing normal vector n. Two non-identical wavefields E^{A} and E^{B} represent two states A and B, respectively. The two vector fields satisfy the wave equations

(∇²+k^{A}^{²})E^{A}=F^{A}

(∇²+k^{B}^{²})E^{B}=F^{B}

where k is the wavenumber and F is the source of force density. It is well known that by inserting special vectors (denoted by Q) into Gauss' theorem,

∫_{V}dV∇·Q= [symbol] _{S}dSn·Q

different Green's vector theorems can be obtained. The specific choice

Q=E^{A}×(∇×E^{B})+E^{A}(∇·E^{B})−E^{B}×(∇×E^{A})−E^{B}(∇·E^{A})

is preferable for the present technique but other vectors may be used. Application of vector calculus rules to ∇·Q, cancelling symmetric terms in E^{A} and E^{B}, and introducing the vector identity ∇²=∇(∇·)−∇×(∇×) yields the expression

∇·Q=E^{A}·∇²E^{B}−E^{B}·∇²E^{A}.

Combining this with the above wave equations and inserting into Gauss' theorem gives:

[symbol]

_{S}dSn·[E^{A}×(∇×E^{B})+E^{A}(∇·E^{B})−E^{B}×(∇×E^{A})−E^{B}(∇·E^{A})=∫_{V}dV[E^{A}·F^{B}−E^{B}·F^{A}−(k^{A}^{²}−k^{B}^{²})E^{A}·E^{B}]. (1)

This is Green's vector theorem for the relationship between the two states A and B. Each of the states may be associated with its own medium parameters and its own distribution of sources. The first two terms of the right side of this expression represent the action of possible sources in V, and vanish if there are no sources present in V. The last two terms under the volume integral represent possible differences in the electromagnetic properties of the media present in the two states. If the media are identical, these two terms vanish. The surface integral takes into account possible differences in external boundary conditions for the electromagnetic fields.

Predicting the Source Radiation Pattern

Green's vector theorem is used as the starting point for predicting the electromagnetic source radiation pattern. The first of the two states, state A, is chosen to be the physical electromagnetic wavefield, the other to be the Green's function of a homogeneous water half-space bounded above by a water-air interface. Provided the physical sources are located above the plane upon which the measurements for the first state are taken, this choice of states allows the estimation of the source radiation pattern. Physical sources beneath the plane (or line) of measurement cannot be determined but will not adversely affect the estimation of the radiation pattern due to sources above the measurement plane.

To predict the source radiation pattern, the geometry illustrated in FIG. 3 is adopted for state A. The closed surface S is set to be the plane (Sᵣ) 6 upon which the physical data measurements are recorded and an upward-closing hemispherical cap (S_{R}) 7 of radius R, resulting in a hemispherical volume V. The surface 5 (S₀) is the air-water interface. The parameters of state A are therefore:

E^{A}=E(x,ω)F^{A}=ζJ(x,ω)

H^{A}=H(x,ω)η^{A}=η(x,ω)

J^{A}=J(x,ω)ζ^{A}=ζ(x,ω)

K^{A}=0.

These fields obey Maxwell's equations, which in the frequency domain can be expressed as

∇×H(x,ω)−η(x,ω)E(x,ω)=J(x,ω)

∇×E(x,ω)+ζ(x,ω)H(x,ω)=K(x,ω).

The wave equation for the electric field is (∇²+k^{A}^{²})E=ζJ, and the assumption of zero volume charge density implies that ∇·E=0.

The geometry adopted for the idealised state B is illustrated in FIG. 4. State B represents the Green's function of a homogeneous water layer half-space bounded above by a water-air interface. The Green's function satisfies outgoing boundary conditions and is causal.

The same surfaces adopted for state A are chosen in state B, although it should be noted that the surface Sr in state B is an arbitrary non-physical boundary, whereas in state A it represents the seabed. Mathematically, requiring the water layer half-space in the idealised state to be homogeneous (only bounded by the air-water surface) is equivalent to requiring outgoing boundary conditions on Sᵣ for the Green's function. In the integral representation of Equation (1) for the electromagnetic field, it is sufficient to consider a scalar Green's function, although a tensor Green's function may also be used The simplest way to relate the vector E^{B} to a scalar Green's function G is to consider E^{B}=Gc, where c is an arbitrary but constant vector. The Green's function satisfies the differential equation

(∇²+k²)G(x,ω;x₀)=−δ(x−x₀),

where x₀ is the source point of the Green's function, and takes into account the sea surface effect.

The source point x₀ of the Green's function is preferably below the recording plane Sᵣ (i.e. outside the volume under consideration). Throughout the volume V the medium parameters for the Green's function are identical to the physical medium parameters. Thus, in state B, within the volume V, the appropriate parameters are

$$\begin{matrix}{E}^{B} = c G ( x , ω , {x}_{0} ) & {F}^{B} = 0 \\ {H}^{B} = \frac{1}{i ω μ} ∇ \times {E}^{B} = \frac{1}{i ω μ} ∇ \times c G ( x , ω , {x}_{0} ) & {η}^{B} = η ( x , ω ) \\ {J}^{B} = 0 & {ζ}^{B} = ζ ( x , ω ) \\ {K}^{B} = 0. & \end{matrix}$$

These parameters may then be inserted into the Green's vector theorem of Equation 1. Further, the radius R of the hemispherical cap S_{R} is allowed to go to infinity so that S_{R} approaches an infinite hemispherical shell; its contribution to the surface integral then vanishes according to the Silver-Müller radiation conditions. This then yields

c·∫_{V}dVζJG=−∫_{S}_{ᵣ}dSn·[E×(∇×cG)+E(∇·cG)−cG×(∇×E)].

Using the vector identities

n·[E×(∇×Gc)]=c·[(n×E)×∇G]

n·[E(∇·cG)]=c·∇G(n·E)

n·[cG×(∇×E)]=c·ζG(n×H)

this then gives

c·∫_{V}dVζJG=−c·∫_{S}_{ᵣ}dS[(n×E)×∇G+(n·E)∇G−ζ(n×H)G].

Since c is an arbitrary vector, then

∫_{V}dVζJG=−∫_{S}_{ᵣ}dS[(n×E)×∇G+(n·E)∇G−ζ(n×H)G].

The Green's function G is associated with electromagnetic wave propagation in the water half-space. The volume integral on the left hand side of the above equation must therefore represent the incident wavefield at x₀ due to the electromagnetic sources. Denoting the incident wavefield E^{(inc)}, where

E^{(inc)}=−∫_{V}dVζJG,

the incident wavefield may be considered as the linear combination of the contribution from all of the elementary sources J(x,ω)dx. The electromagnetic source wavefield at any point x₀ below the sensor plane for any unknown and/or distributed source with an anisotropic radiation pattern above the sensor plane can therefore be expressed as

E^{(inc)}(x₀,ω)=∫_{S}_{ᵣ}dS[(n×E)×∇G+(n·E)∇G−ζ(n×H)G]. (2)

The points x₀ can be chosen anywhere on or below Sᵣ. By evaluating Equation (2) at the points x₀ coinciding with the locations of the sensors used to acquire the measured data, the incident wavefield due to the source is obtained at the sensors. Evaluating Equation (2) for various values of x₀, for example at a constant radius about a known source location, the relative strength of the source radiation pattern as a function of angle can be obtained.

Equation (2) can be written in component form for x=(x₁,x₂,x₃) and x₀=(x₁₀,x₂₀,x₃₀) as

E₁^{(inc)}(x₀,ω)=∫_{S}_{ᵣ}dS[E₁∂₃G+E₃∂₁G+ζH₂G] (3a)

E₂^{(inc)}(x₀,ω)=∫_{S}_{ᵣ}dS[E₂∂₃G+E₃∂₂G−ζH₁G] (3b)

E₃^{(inc)}(x₀,ω)=∫_{S}_{ᵣ}dS[E₃∂₃G−(E₁∂₁+E₂∂₂)G] (3c)

Where Eᵢ=Eᵢ(x₁,x₂,x₃,ω), Hᵢ=Hᵢ(x₁,x₂,x₃,ω) G=G(x₁₀,x₂₀,x₃₀,ω; x₁,x₂,x₃), dS=dS(x₁,x₂), ∂ᵢ=∂/∂xᵢ, and i=1,2,3.

Equations 2 and 3a to 3c are solely dependent upon the incident electromagnetic field. This must be so since the left hand side depends on the incident field in the water layer half-space only. On the right hand side, the total fields depend on both the incident wavefield and the subsurface properties of the earth. However, the integral acts like a filter to eliminate all waves except the incident electromagnetic wavefield. The right hand side therefore also only depends on the incident wavefield. Therefore, measurements of the electric and magnetic fields alone are sufficient to determine the source radiation pattern without any information about the subsurface.

Equation 2 depends on the normal component of the electric field to the surface Sr through the term n·E. For a horizontal recording plane, n·E=E₃ is the vertical component of the electric field (assuming the depth axis to be positive downwards). If the normal component is not measured, the solution for the source radiation pattern can be expressed in terms of the tangential (horizontal) field components on Sᵣ. This may be demonstrated by eliminating E₃ using Maxwell's equation,

$${E}_{3} = \frac{1}{i ω \tilde{ɛ}} ( {\partial }_{2} {H}_{1} - {\partial }_{1} {H}_{2} ) .$$

Since G=G(x₁₀−x₁,x₂₀−x₂,x₃₀,ω;x₃), the integral over n·E in Equation 2 is a two-dimensional spatial convolution over the horizontal coordinates which may be integrated by parts to give

E₁^{(inc)}(x₀,ω)=∫_{S}_{ᵣ}dS{E₁∂₃G−(iω\tilde{ε})⁻¹[H₁∂₁∂₂G−H₂(∂₁²+k²)G]} (4a)

E₂^{(inc)}(x₀,ω)=∫_{S}_{ᵣ}dS{E₂∂₃G−(iω\tilde{ε})⁻¹[H₂∂₁∂₂G−H₁(∂₂²+k²)G]} (4b)

E₃^{(inc)}(x₀,ω)=−∫_{S}_{ᵣ}dS{(E₁∂₁+E₂∂₂)G+(iω\tilde{ε})⁻¹E₃(H₁∂₂−H₂∂₁)∂₃G}. (4c)

The corresponding source magnetic fields may be obtained from Equations 3a to 3c and 4a to 4c using the relationship H^{(inc)}=−ζ⁻¹∇×E^{(inc)}.

The predicted radiation pattern can be used for modelling, processing and further interpretation of marine electromagnetic data. For example, the determined source radiation pattern can be extracted from the measured data, leaving data corresponding only to the region beneath the sensor plane, i.e. the seabed if the sensors are placed there.

The data processing methods described above may be embodied in a program for controlling a computer to perform the technique. The program may be stored on a storage medium, for example hard or floppy discs, CD or DVD-recordable media or flash memory storage products. The program may also be transmitted across a computer network, for example the Internet or a group of computers connected together in a LAN.

The flow diagram of FIG. 5 illustrates the method of an embodiment of the present invention. Data is acquired during a marine electromagnetic survey at step 30, in an environment as illustrated in FIG. 1. At step 31 the Green's function for the idealised water half-space is computed, and then its spatial derivatives obtained (step 32). A surface integral over data weighted by the Green's function and its spatial derivatives as described above is then formulated and subsequently evaluated (step 33) at a location at or beneath the plane upon which the measurements were recorded. This yields the source radiation pattern (step 34).

The schematic diagram of FIG. 6 illustrates a central processing unit (CPU) 13 connected to a read-only memory (ROM) 10 and a random access memory (RAM) 12. The CPU is provided with data 14 from the receivers via an input/output mechanism 15. The CPU then determines the source radiation pattern 16 in accordance with the instructions provided by the program storage (11) (which may be a part of the ROM 10). The program itself, or any of the inputs and/or outputs to the system may be provided or transmitted to/from a communications network 18, which may be, for example, the Internet. The same system, or a separate system, may be used to modify the EM-SBL data to remove the source radiation pattern from the recorded data, resulting in modified EM-SBL data 17 which may be further processed.

It will be appreciated by the skilled person that various modifications may be made to the above embodiments without departing from the scope of the present invention, as defined in the appended claims.

1-32. (canceled)

33. A method of determining the source radiation pattern of at least one source of electromagnetic radiation, comprising the steps of:
measuring the electric and magnetic fields due to the at least one source at at least one sensor;
formulating a surface integral over the measured data weighted by a Green's function and its spatial derivatives; and
evaluating the surface integral at at least one location to determine the source radiation pattern at that location due to the at least one source.

34. A method as claimed in claim 33, wherein the surface integral is derived using Green's vector theorem for two non-identical states.

35. A method as claimed in claim 34, wherein the first state is a real physical state and the second state is an idealised state.

36. A method as claimed in claim 35, wherein the real physical state comprises a plane containing the at least one sensor.

37. A method as claimed in claim 35, wherein the idealised state comprises a half-space bounded above by an interface.

38. A method as claimed in claim 37, wherein the half-space is a semi-infinite water layer bounded above by a water-air interface.

39. A method as claimed in claim 34, wherein the two non-identical states have the same medium properties above a plane containing the at least one sensor.

40. A method as claimed in claim 33, wherein the Green's function is a scalar Green's function.

41. A method as claimed in claim 33, wherein the Green's function is a tensor Green's function.

42. A method as claimed in claim 33, wherein the Green's function describes electromagnetic wave propagation.

43. A method as claimed in claim 33, wherein the Green's function describes electromagnetic diffusion.

44. A method as claimed in claim 42 wherein the real first state is a physical state and the second state is an idealized state and, wherein the Green's function describes electromagnetic waves in the idealised state.

45. A method as claimed in claim 33, wherein the surface integral used to determine the source electric field radiation pattern E^{(inc)} is given by E^{(Inc)}(x₀,ω)=∫_{S}_{ᵣ}dS[(n×E)×∇G+(n·E)∇G−ζ(n×H)G], where the incident electric wavefield is evaluated at a location x₀, ω is the angular frequency, Sᵣ is the surface over which the integration is taken, n is a normal vector to the surface, E is the electric field strength, H is the magnetic field strength, G is a Green's function, and ζ is the longitudinal impedance per length of the medium.

46. A method as claimed in claim 33, wherein the surface integral used to determine the source magnetic field radiation pattern H^{(inc)} is given by H^{(inc)}(x₀,ω)=−ζ⁻¹∇×∫_{S}_{ᵣ}dS[(n×E)×∇G+(n·E)∇G−ζ(n×H)G], where the incident magnetic wavefield is evaluated at a location x₀, ω is the angular frequency, Sᵣ is the surface over which the integration is taken, n is a normal vector to the surface, E is the electric field strength, H is the magnetic field strength, G is a Green's function, and ζ is the longitudinal impedance per length of the medium.

47. A method as claimed in claim 45, wherein the value of the surface integral is approximated using a method of numerical integration.

48. A method as claimed in claim 33, wherein the surface integral is evaluated at the location of the at least one sensor.

49. A method as claimed in claim 33, wherein the surface integral is evaluated at any location beneath the location of the at least one sensor.

50. A method as claimed in claim 33, wherein the surface integral is evaluated at locations that are a constant radius about a known source location to provide the source radiation pattern as a function of angle.

51. A method as claimed in claim 33, wherein the at least one sensor is for use in electromagnetic seabed logging (EM-SBL).

52. An apparatus for determining the source radiation pattern of at least one source of electromagnetic radiation, comprising:
at least one sensor for measuring the electric and magnetic fields due to the at least one source;
means for formulating a surface integral over the measured data weighted by a Green's function and its spatial derivatives; and
means for evaluating the surface integral at at least one location to determine the source radiation pattern at that location due to the at least one source:

53. A method of processing electromagnetic data, the method comprising:
determining the source radiation pattern of at least one electromagnetic source in accordance with a method as claimed in claim 33;
comparing the source radiation pattern to electromagnetic data recorded at the at least one sensor; and
separating the source radiation pattern and the measured electromagnetic data.

54. A method as claimed in claim 53, wherein the source radiation pattern is removed.

55. A method as claimed in claim 53, wherein the data is EM-SBL data and the at least one sensor is disposed upon the seabed.

56. Data obtained by a method of processing electromagnetic data as claimed in claim 53.

57. Data as claimed in claim 56 when stored on a storage medium.

58. A program for controlling a computer to perform a method as claimed in claim 33.

59. A program as claimed in claim 58 stored on a storage medium.

60. Transmission of a program as claimed in claim 58 across a communications network.

61. A computer programmed to perform a method as claimed in claim 33.

62. Use of the source radiation pattern of at least one source of electromagnetic radiation as determined in accordance with the method of claim 33 for modelling electromagnetic data.

63. Use of the source radiation pattern of at least one source of electromagnetic radiation as determined in accordance with the method of claim 33 for processing electromagnetic data.

64. Use of the source radiation pattern of at least one source of electromagnetic radiation as determined in accordance with the method of claim 33 for interpreting electromagnetic data.
